(19) United States
(12) Patent Application Publication
(10) Pub. No.: US 2021/0278579 A1
(43) Pub. Date: Sep. 9, 2021

(54) FIELD FLATTENING VIA INTERFERENCE FILTERS

(71) Applicant: BAE Systems Information and Electronic Systems Integration Inc., Nashua, NH (US)

(72) Inventor: Jacob D. Garan, Honolulu, HI (US)

(73) Assignee: BAE Systems Information and Electronic Systems Integration Inc., Nashua, NH (US)

(21) Appl. No.: 16/716,921

(22) Filed: Dec. 17, 2019

(51) Int. Cl. G02B 5/28; G02B 5/20

(52) U.S. Cl. CPC G02B 5/288; G02B 5/208

(57) ABSTRACT

The present disclosure relates generally to a method of use for a field flattening interference filter. More particularly, the present disclosure relates a field flattening bandpass interference filter with the cut-on edge of the pass band at the system wavelength at a normal angle of incidence. Further discussed is a method to extend the field flattening design to work at multiple system wavelengths through the optimized design of a multi-band interference filter.

### STATEMENT OF GOVERNMENT INTEREST

The invention was made with United States Government support under Contract No. N000 14-16-C-3059, U.S. Navy awarded by the United States Navy. The United States Government has certain rights in this invention.

### TECHNICAL FIELD

The present disclosure relates generally to a method of use for a field flattening interference filter. More particularly, the present disclosure relates a field flattening bandpass interference filter. Specifically, the present disclosure relates to a field flattening bandpass interference filter with the short wavelength or “cut-on” edge of the passband coinciding with the monochromatic band of interest.

### BACKGROUND

An interference filter, also called a dichroic filter, is a type of optical filter that reflects one or more spectral bands or lines and transmits others, while maintaining highly efficient transmission for all wavelengths of interest within the pass band. Interference filters may be high-pass, low-pass, bandpass, or band-rejection. High-pass interference filters pass signals through that are higher than a certain frequency while rejecting (or attenuates) those lower than that frequency. Low-pass interference filters do the opposite, namely pass signals that are lower than a certain frequency while rejecting those that are higher. Band pass interference filters are filters that pass a range of frequencies while band-rejection filters reject a given range of frequencies.

Generally interference filters are constructed of multiple thin layers of dielectric material that have different refractive indices. There also may be metallic layers within the filter. As a result of these layers of dielectric material and metallic layers interference filters may be wavelength-selective by virtue of the interference effects that take place between the incident and reflected waves at the thin-film boundaries. The layers are typically deposited on a substrate plate that is optically transparent for the design basis spectrum and may be optically uniform over the area of the plate for high spectral selectivity interference filters.

Bandpass filters are commonly designed for use at a normal angle of incidence. But, when the angle of incidence (AOI) of the incoming light is increased from zero, the pass band of the filter shifts to pass shorter wavelengths than at normal incidence, resulting in the ability to tune the passband characteristics of the filter. The transmission band is able to widen and the maximum transmission decreases. If λ′(θ) is the central wavelength, λ₀ is the central wavelength at normal incidence, and n_{eff} is the filter effective index of refraction, then:

$${λ}^{′} ( θ ) = {λ}_{0} \sqrt{1 - {( \frac{sin ( θ )}{{n}_{eff}} )}^{2}} \qquad ( 1 )$$

The passband wavelength range of interference filters shift as a function of their AOI, as expressed in the equation (1) above.

Active imaging applications often experience limitations in dynamic range due to illumination rolloff, which is commonly introduced by the lens, vignetting and non-uniform illumination. Rolloffs are the decrease in relative illumination with respect to field that is not caused by vignetting, but by radiometric laws. Vignetting is the partial or complete blocking of ray bundles passing through an optical system. While the angle-dependence of bandpass interference filters is often considered a nuisance, it can be intentionally used to cancel out rotationally symmetric rolloff across the field of view (FOV) of a monochromatic imaging system.

The performance of active illumination imaging systems with a wide field of view are often limited by the compounded rolloff of the illumination source and receiver optics. An existing solution to uniform wide-field illumination involves the use of diffusers or diffractive optics, however these optical elements are complicated to fabricate and introduce wavefront aberrations that pose limitation for interferometric applications such as shearography. While an aspheric beam shaper may also be used to correct the illumination rolloff, these components are also complicated to fabricate and require tight positioning tolerances to produce the desired correction effects.

### SUMMARY

By designing the filter to have a maximum transmission at longer wavelength than the system wavelength, the rays entering the system at higher angles of incidence (AOI) pass with higher transmission than the rays that pass at a normal AOI.

In one aspect, an exemplary embodiment of the present disclosure may provide a method for designing a bandpass interference filter comprising: providing a bandpass interference filter wherein the filter has a bandpass cut-on edge designed to overlap with a system wavelength at a normal angle of incidence (AOI) and a maximum transmission for longer wavelengths within the passband at normal AOI; and passing light at the system wavelength from higher AOI with higher transmission than light at the system wavelength at lower AOI. This exemplary embodiment or another may provide uniform transmission at the image sensor of a system to abate rolloff effects. This exemplary embodiment or another may provide compensating for a lens illumination rolloff; and compensating for a rotationally symmetric illumination profile from a light transmission source. This exemplary embodiment or another may provide combining the lens illumination rolloff and the rotationally symmetric illumination profile from a transmitter to result in a system level illumination profile. This exemplary embodiment or another may provide the angle of incidence is about 0 to about 30 degrees. This exemplary embodiment or another may providing placing the bandpass interference filter at an aperture stop of the optical system. This exemplary embodiment or another may provide placing the bandpass interference filter in a system location with the smallest variation of light angle of incidence per pixel. This exemplary embodiment or another may provide changing the optical density of the bandpass interference filter through use of added absorptive or scattering media.

In another aspect, an exemplary embodiment of the present disclosure may provide a method for designing a multi-band bandpass interference filter comprising: designing a multi-band interference filter such that a first cut-on edge and at least one second cut-on edge of a first passband and at least one second passband, respectively, lie on a first system wavelength of interest and at least one second system wavelength of interest, respectively, and optimizing the design methodology used for a single-band field-flattening interference filter. This exemplary embodiment or another may provide tabulating a plurality of combinations of band locations and bandwidth over a range of probable values based on an angle of incidence of a system, evaluating a plurality of desired interference filters against constraint criteria, and further evaluating the plurality of desired interference filters against performance criteria. This exemplary embodiment or another may provide wherein the angle of incidence is about 0 to about 30 degrees. This exemplary embodiment or another may provide compensating for a lens illumination rolloff; and compensating for a rotationally symmetric illumination profile from a light transmission source. This exemplary embodiment or another may provide combining the lens illumination rolloff and the rotationally symmetric illumination profile from a transmitter to result in a system level illumination profile.

In yet another aspect, an exemplary embodiment of the present disclosure may provide a method of determining an optimal interference filter comprising: tabulating a plurality of combinations of band locations and bandwidth over a range of probable values based on angle of incidence of a system, evaluating a plurality of desired interference filters against constraint criteria, and further evaluating the plurality of desired interference filters against performance criteria. This exemplary embodiment or another may provide evaluating the plurality of interference filters by additional criteria. This exemplary embodiment or another may provide real world performance criteria and manufacturing criteria. This exemplary embodiment or another may provide adjusting the design of at least one of the plurality of interference filters based on the additional criteria. This exemplary embodiment or another may provide changing the optical density of the bandpass interference filter through use of added absorptive or scattering media. This exemplary embodiment or another may provide the additional criteria comprise constraint criteria, performance criteria, manufacturing criteria, real world performance criteria or any combination thereof. This exemplary embodiment or another may provide repeating the steps until a single interference filter is remaining; and choosing the single interference filter for the system.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the wavelength boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a diagrammatic view of a bandpass filter.

FIG. 2 is a graph of bandpass interference filter performance vs. AOI.

FIG. 3 is a graph for a given transmission at an exemplary system wavelength of 682 nm for a bandpass interference filter.

FIG. 4A is a graph relating to modeling of the filter transmission percentage based on X and Y changes of the field of view.

FIG. 4B is a graph relating to the lens relative illumination percentage based on X and Y changes of the field of view.

FIG. 4C is a graph relating to the lens relative illumination with the filter added to the lens.

FIG. 5 is a flow chart of an exemplary method.

Similar numbers refer to similar parts throughout the drawings.

### DETAILED DESCRIPTION

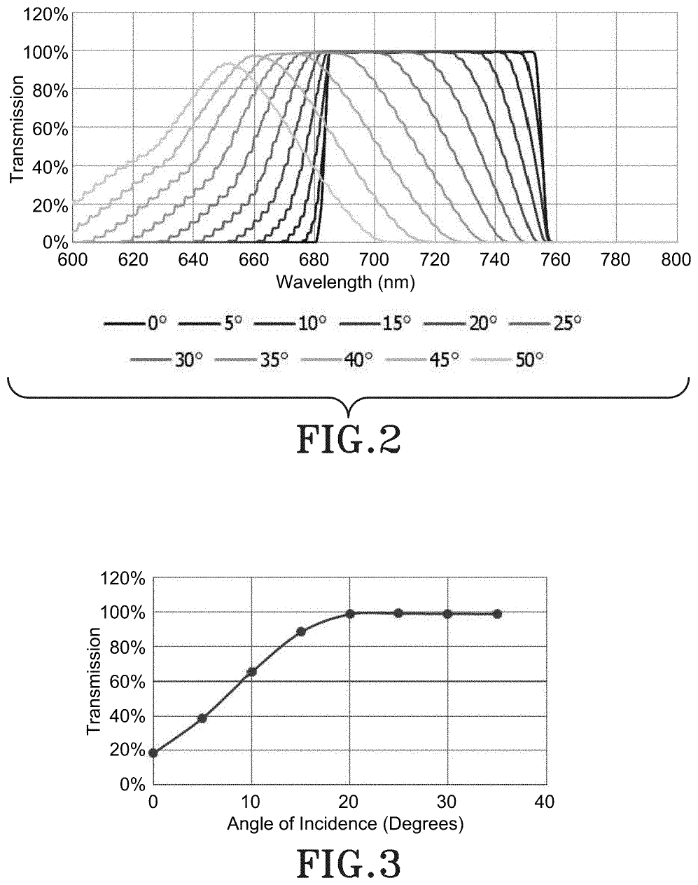

A new bandpass interference filter method of manufacture and method of operation thereof is depicted in the present disclosure and throughout FIGS. 2-5. The disclosure focuses on improved method of using a bandpass interference filter, as will be discussed hereafter.

The angle-dependence of bandpass interference filters can be intentionally used to cancel out rotationally symmetric rolloff across the FOV of a monochromatic imaging system. The present disclosure provides, according to one example instead of changing the illumination rolloff with absorption-based attenuation, an imaging system uses a bandpass interference filter design.

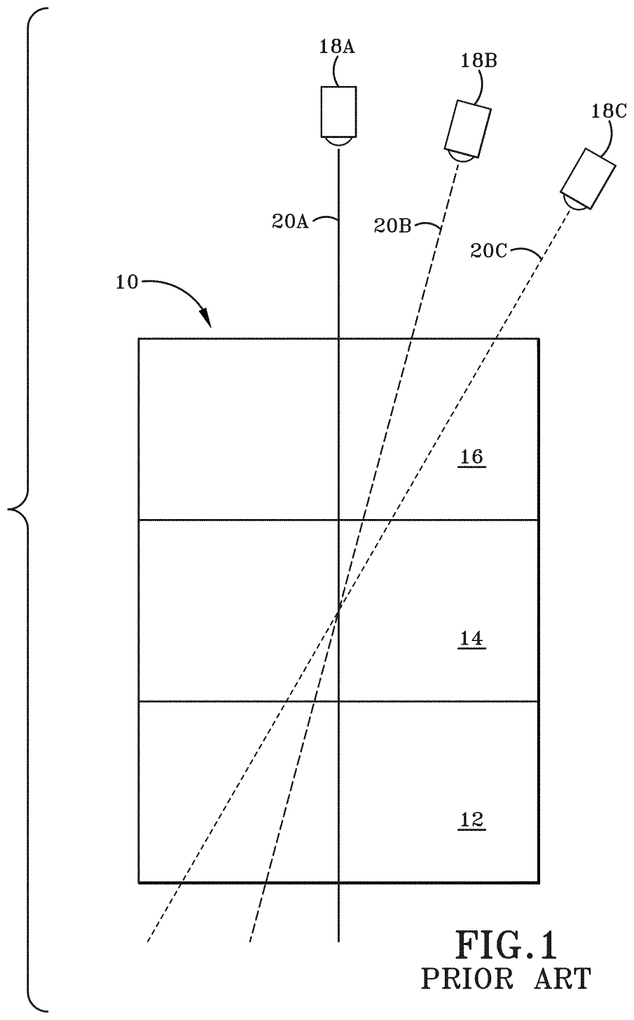

For example FIG. 1 shows a traditional bandpass filter 10 that has been obtained from a commercial supplier. The traditional bandpass filter 10 has a plurality of layers 12, 14, 16, with varying properties depending on the ultimate use. While for illustrative purposes the bandpass filter has three layers 12, 14, 16, any number of layers may be used.

A first radiation source 18A may provide at least one collimated beam of light 20A. There may be a plurality of beams of light may occur at multiple angles. As As the AOI of the collimated radiation source to a second radiation source 18B with a second at least one beam of light 20B, and further to a third radiation source 18C with a third at least one beam of light 20C, the bandpass filter 10 transmission performance changes.

Referring now to FIG. 2, a bandpass interference filter performance vs. AOI graph is shown. As can be seen, there are multiple overlapping plots showing changes to transmission vs. wavelength performance over a range of AOI's from 0 degrees to 50 degrees. Depending on the AOI, the passband transmission and wavelength range changes. As can be seen increasing the angle of incidence tends to shift the passband central wavelength to shorter wavelengths over the shown range of angles. The passband in this bandpass interference filter is approximately 680-700 nm.

In many imaging systems, the brightest portion of the image is at the center of the field of view. As the AOI increases, the passband wavelength range of the interference filter shifts to shorter wavelengths, increasing the transmission towards the edge of the FOV. For large AOI the passband performance becomes more difficult to make use of either due to reduced transmission, non-uniform variations in transmission over the wavelength range, and the introduction of more significant polarization effects.

Examples of the present disclosure take advantage of the angle-dependence of optical interference filters, namely, as discussed earlier, as the angle of incidence changes, the path length through each filter layer also changes. In order to correct rolloff from the center of the FOV, the bandpass interference filter can be designed to have a maximum transmission at a wavelength slightly longer than the system wavelength. This design is operative to work for imaging and illumination systems with narrow wavelength ranges. Further, one embodiment may provide for a multi-band bandpass filter that can be used for multiple wavelengths simultaneously. For example, in one embodiment, two separate bands at 1064 nm and 532 nm may be used, but bandwidths of each interference filter still should to be monochromatic for the design to work as-intended.

An exemplary embodiment of the design offers the convenience of being easily mounted in front of a lens, in the lens, at the system aperture stop, or behind the lens using a coating design that many vendors should be able to support. Additionally, the design is in turn simple to model accurately. It is advantageous to pick a design coating with a curve that has a rising edge near the system wavelength. As such, the coating design can be tuned so that as the angles change the transmission changes, along with the ability to correct non-uniform transmission. The system wavelength is typically the bandpass interference filter angle which is a slightly longer wavelength.

FIG. 3 is shown for a given transmission at 682 nm. This transmission is shown to increase from 0-35 degrees, where there is about 100% transmission at AOI that are 20 degrees or higher. At generally high angles of incidence such as 30 degrees, the coating performance becomes more difficult to control. A range of AOI from 0 to 30 degrees serves as a design constraint that is generally free of more complicated effects such as polarization-dependence. This is dependent on the coating design. However, there are design factors that may be used in order to get these values higher by optimizing the interference filter. This may include, but is not limited to varying the material choice of the filter layers, the level of attenuation of the filter media as well as thickness of the individual layers. It should be noted that as the AOI increases, so does the dependence of transmission performance as a function of the polarization state of the light. One method to mitigate this effect is to circularly polarize the incident light.

The bandpass interference filter design may be optimized by an iterative process. During the design process, the filters' transmission vs. AOI performance may be predicted and simulated. Based on these predictions and simulations, system illumination rolloff profiles may be created and compared to what properties and design factors are desired. Then, the design may be altered and subject to further prediction and simulations. This design process may be repeated until the system illumination rolloff performance requirements are met. The polarization effects will increase with increasing angle of incidence. Since this bandpass interference filter is, in one embodiment, designed to go in front of a lens, the polarization-dependent transmission will decrease with increasing field angles: where polarization states azimuthal to the center of the FOV will reflect and polarization states radial to the center of the FOV will pass. However, the polarization effects have been shown in models to significantly decrease with decreasing FOV, the effect should be negligible for AOI of greater than about 10 degrees.

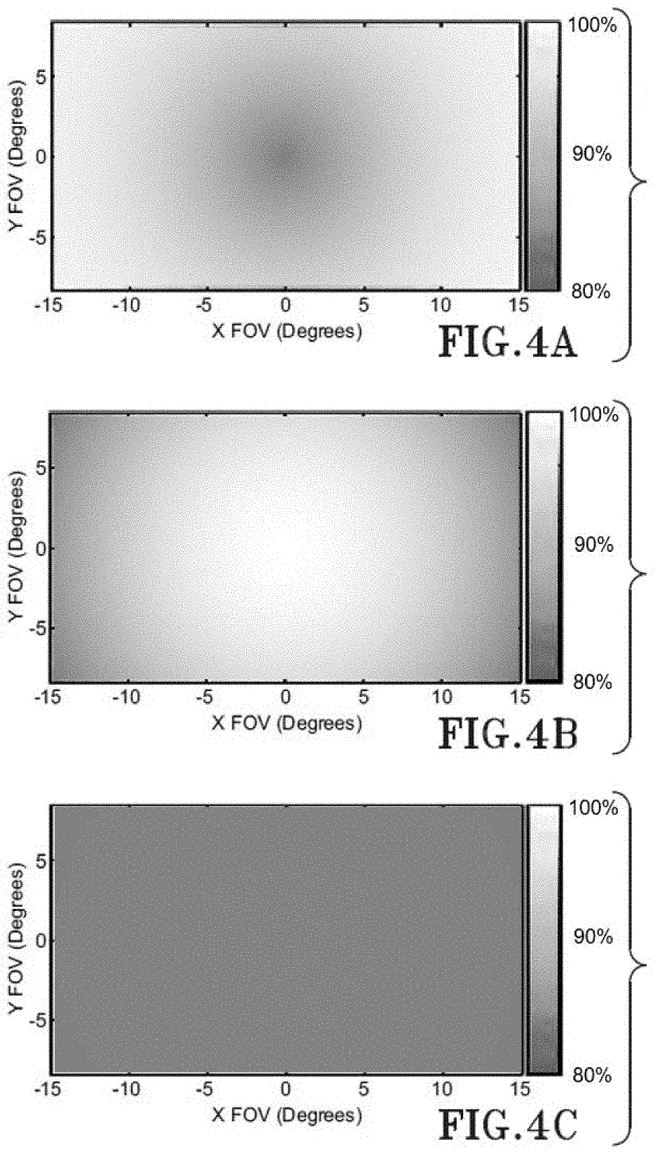

Referring specifically to FIGS. 4A, 4B and 4C, various graphs relating to modeling of the illumination and transmission with and without the bandpass interference filter are shown. Referring specifically to FIG. 4A, a distribution of transmission is shown. The bandpass interference filter is not meant to increase the total transmission efficiency but instead flatten the response. In this context, field-flattening means the imaging system transmission does not have a dependence on field angle. The system transmission is uniform across the focal plane. The signal at each pixel in an imaging system typically depends on its field angle with respect to the optical system, its instantaneous FOV, and the radiometric properties of the optical system and pixel. The illumination rolloff referred to within the disclosure refers to field-angle dependent signal rolloff, however the signal can also rolloff across other system parameter such as an objective lens' F/# and instantaneous FOV. As field angles of FIG. 4A-4C increase in magnitude, so does the relative transmission of the interference filter.

Referring specifically to FIG. 4B, this figure shows a common field dependent rolloff across an image sensor without the use of a field flattening interference filter. This relative illumination profile in this figure is based on cos\hat{ }4 rolloff. Namely, a given object luminance and a given lens setup, the illuminance on the film plane falls off as the fourth power of the cosine of the off-axis angle of the area on the object, where the angle is measured in “object space” from the center of the entrance pupil.

In short, if a light was shone onto the sensor, it would be the brightest at nearest points to 0 degrees X and 0 degrees on the Y and begin to roll off the further degrees away from the source. This relative illumination profile in this figure is based on cos\hat{ }4 rolloff. Namely, a given object luminance and a given lens setup, the illuminance on the film plane falls off as the fourth power of the cosine of the off-axis angle of the area on the object, where the angle is measured in “object space” from the center of the entrance pupil.

Referring specifically to FIG. 4C, this shows the relative illumination across the image plane and system FOV with the bandpass interference filter added. In this case, the center of the light is by one edge of the bandpass interference filter and as the light passes through more bandpass interference filter at the steeper end of the wavelength is shifted to shorter wavelengths. Then, by attenuating the center and applying a transition mask, a uniform response for transmission may be obtained.

An alternative method for flattening the field response is an apodized neutral density (ND) filters, however traditional absorptive ND filters can introduce more scattering effects than an interference filter. The reduced amount of scattering and wavefront error in the interference-based field flattening filter makes it a better solution for sensitive application such as interferometry where there is little tolerance for additional wavefront errors. Traditional absorptive ND filters can introduce more scattering effects than an interference filter, resulting in a range of ray paths that are typically undesirable in optical systems.

It should be noted that the spectral bandpass curves are sensitive to polarization states for non-normal angles of incidence. It should also be noted that the bandpass interference filter will be sensitive to polarization states for non-normal angles of incidence.

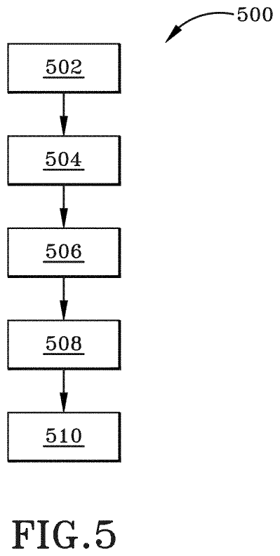

In one embodiment, a method 500 of determining an optimal bandpass interference filter is shown in FIG. 5. The method can provide simulating transmission performance at all combinations of band locations and bandwidths over a range of probable values based on AOI of a system 502, evaluating each desired bandpass interference filter against constraint criteria 504 and further evaluating each desired bandpass interference filter against performance criteria 506, selecting the subset of filters that pass the constraint criteria 508, and selecting the best performing filter among the subset to be at least one trial bandpass interference filter 510.

Simulating transmission performance at all combinations of band locations and bandwidths over a range of probable values based on AOI of a system 502 may occur by using iterative derived software or a workstation to output information based on specific queries to data bearing records. The outputs of which may then be evaluated against various criteria. The evaluating each desired bandpass interference filter against constraint criteria 504 and further evaluating each desired bandpass interference filter against performance criteria 506 may include but are not limited to, real world performance criteria and manufacturing criteria. The real world performance criteria would involve actually using the filter and gaining data to determine if it performs similar to expected within simulations. After evaluating the at least one trial bandpass interference filter for the additional criteria, adjustments may be made to one, each, or all at least one trial bandpass interference filter. This adjustment may then require a second set of constraint criteria, performance criteria, manufacturing criteria, real world performance criteria or any combination thereof the optimization procedure to provide a second set of at least one second trial filter. Then, the at least one second trial filter may be tested and executed with the optimization procedure to provide a second set of at least one second trial filter. This may be done until a desired filter is picked.

In another exemplary embodiment, a method for designing a bandpass interference filter is contemplated. The method includes designing a bandpass interference filter that has a cut-on transition at the system wavelength, maximum transmission at a longer wavelength than a system wavelength, such that light at the system wavelength at higher angles of incidence will pass with higher transmission than light at the system wavelength at a normal angle of incidence through the bandpass filter. Designing the interference filter includes compensating for a lens illumination rolloff and further compensating for a rotationally symmetric illumination profile from a transmitter. The compensations from the lens illumination rolloff and the rotationally symmetric illumination profile from a transmitter may be combined to result in an illumination profile. The absolute value of the higher angles of incidence are about 0 and about 30. In other embodiments they may be as high as 50 degrees. The bandpass interference filter can be placed at many places, as previously discussed, in the system, but in one embodiment it is located at a stop of the system. The bandpass interference filter, if not at the stop, is placed where the rays of light have the lowest rate of incidence. These modifications and designing is all done without changing the density of the bandpass interference filter.

In yet another embodiment, a multi-band interference filter may be designed with as many bandpass regions as system wavelengths desired, where the first system wavelength lies within the cut-on edge of the first passband and the second system wavelength lies on the cut-on edge of the second passband. Similar to above the operable angle of incidence range of this multi-band interference filter is between 0 degrees and about 30 degrees off the surface normal. In other embodiments, they may be as high as 50 degrees AOI.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or smartphone utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other nontransitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software, and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, any method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clarity, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. A method comprising:
providing a bandpass interference filter wherein the filter has a bandpass cut-on edge designed to overlap with a system wavelength at a normal angle of incidence (AOI) and a maximum transmission for longer wavelengths within the passband at normal AOI; and
passing light at the system wavelength from a higher AOI with higher transmission than light at the system wavelength at a lower AOI.

2. The method of claim 1, further comprising:
flattening a transmission response from the system to ensure a detector of the system receives uniform illumination to abate rolloff effects.

3. The method of claim 1, wherein providing further comprises:
compensating for illumination rolloff of a lens; and compensating for a rotationally symmetric illumination profile from a light transmission source.

4. The method of claim 3, further comprising: combining the lens illumination rolloff and the rotationally symmetric illumination profile from a transmitter to result in a system level illumination profile.

5. The method of claim 1, wherein the angle of incidence is about 0 to about 30 degrees.

6. The method of claim 1, further comprising:
placing the bandpass interference filter at an aperture stop of the optical system.

7. The method of claim 1, further comprising:
placing the bandpass interference filter in a system location with the smallest variation of light angle of incidence per pixel.

8. The method of claim 3, wherein designing does not include:
changing the optical density of the bandpass interference filter through use of added absorptive or scattering media.

9. A method for designing a multi-band bandpass interference filter comprising:
designing a multi-band interference filter such that a first cut-on edge and at least one second cut-on edge of a first passband and at least one second passband, respectively, lie on a first system wavelength of interest and at least one second system wavelength of interest, respectively, and
optimizing the design for a single-band field-flattening interference filter.

10. The method of claim 9, wherein the optimizing step comprises:
tabulating a plurality of combinations of band locations and bandwidth over a range of probable values based on an angle of incidence of a system;
evaluating a plurality of desired interference filters against constraint criteria; and
further evaluating the plurality of desired interference filters against performance criteria.

11. The method of claim 10, wherein the angle of incidence is about 0 to about 30 degrees.

12. The method of claim 9, wherein optimizing further comprises:
compensating for illumination rolloff of a lens; and
compensating for a rotationally symmetric illumination profile from a light transmission source.

13. The method of claim 12, further comprising: combining the lens illumination rolloff and the rotationally symmetric illumination profile from a transmitter to result in a system level illumination profile.

14. A device comprising:
a bandpass interference filter a maximum transmission at a longer wavelength than a system wavelength, wherein the cut-on edge of a passband coinciding with the monochromatic band, wherein light at the system wavelength at higher angles of incidence will pass with higher transmission than light at the system wavelength at a normal angle of incidence through the bandpass interference filter.

15. The device of claim 14, wherein the higher angles of incidence are about 0 to about 30 degrees.

16. The device of claim 14, wherein the bandpass interference filter is placed in the system where there is the lowest rate of incidence of light.

17. The device of claim 14, wherein the bandpass interference filter allows for compensation for a lens illumination rolloff.

18. The device of claim 14, wherein the bandpass interference filter provides a rotationally symmetric illumination profile from a transmitter.

19. The device of claim 14, wherein the bandpass interference filter is placed at a stop of the system.

20. The device of claim 14, wherein the bandpass interference filter properties are not changed through use of added absorptive or scattering media.
